(19) United States
(12) Patent Application Publication
(10) Pub. No.: US 2020/0346333 A1
(43) Pub. Date: Nov. 5, 2020

(54) PNEUMATIC NAIL GUN AND OPERATION METHOD THEREOF

(71) Applicant: Basso Industry Corp., Taichung (TW)

(72) Inventors: Chien-Kuo Po, Taichung (TW); Hung-He CHEN, Taichung (TW)

(73) Assignee: Basso Industry Corp., Taichung (TW)

(21) Appl. No.: 16/859,186

(22) Filed: Apr. 27, 2020

(30) Foreign Application Priority Data
Apr. 30, 2019 (TW) 108115062

(51) Int. Cl. B25C 1/04; B25C 1/00

(52) U.S. Cl. CPC B25C 1/047; B25C 1/008

(57) ABSTRACT

A pneumatic nail gun includes a striking device, a lifting wheel, a motor that is configured to drive the lifting wheel to rotate to lift the striking device, and a control device. The control device includes a microcontroller, and a sensor configured to output a sensing signal when detecting that the lifting wheel is at a predetermined angular position where the lifting wheel has lifted the striking device to arrive at a ready-to-strike position. The microcontroller controls the motor to drive the lifting wheel to rotate to lift the striking device when the sensing signal is not received, and controls the motor to stop the lifting wheel from rotating upon receiving the sensing signal from the sensor.

### CROSS-REFERENCE TO RELATED APPLICATION

This application claims priority of Taiwanese Patent Application No. 108115062, filed on Apr. 30, 2019.

### FIELD

The disclosure relates to a pneumatic tool, more particularly to a pneumatic nail gun.

### BACKGROUND

Referring to FIG. 1, a conventional pneumatic nail gun 1 as disclosed by U.S. Pat. No. 8,011,547 includes a main body 11, a muzzle 12 connected to the main body 11 and adapted to be loaded with a nail 2, a lifting wheel 13 rotatably connected to the muzzle 12, a cylinder 14 mounted in the main body 11, a piston 15 movable within the cylinder 14, and a driver 16 connected with the piston 15 and adapted to be driven in the muzzle 12 and to strike the nail 2. The driver 16 includes a striking portion 161, and a row of engaging teeth 162 engaging the lifting wheel 13.

When the lifting wheel 13 is driven to rotate, the driver 16 is linearly moved in a direction towards a rear side (towards the top of FIG. 1) of the main body 11 due to engagement between the lifting wheel 13 and the row of engaging teeth 162, so the piston 15 compresses air inside the cylinder 14. When the driver 16 arrives at a ready-to-strike position and the lifting wheel 13 disengages the row of engaging teeth 162, air pressure of the compressed air in the cylinder 14 drives the driver 16 to move away from the rear side of the main body 11, striking the nail 2 with the striking portion 161.

If some type of jam occurs and causes the driver 16 to be unable to complete its travel to the fullest extent during a driving stroke, the conventional pneumatic nail gun 1 should be powered off and disassembled to resolve the jam. However, even if the jam has been resolved, the driver 16 may still be at an abnormal position. The conventional pneumatic nail gun 1 may be damaged if the user tries to move the driver 16 to the ready-to-strike position in an inappropriate manner.

### SUMMARY

Therefore, the object of the disclosure is to provide an operation method for operating a pneumatic nail gun that can alleviate at least one of the drawbacks of the prior art.

According to the disclosure, a pneumatic nail gun includes a striking device, a lifting wheel, a motor that is configured to drive the lifting wheel to rotate to lift the striking device, and a control device that includes a microcontroller and a wheel sensor electrically connected to the microcontroller. The wheel sensor is configured to generate and output a sensing signal to the microcontroller when detecting that the lifting wheel is at a predetermined position where the lifting wheel has lifted the striking device to arrive at a ready-to-strike position.

The operation method is implemented by the microcontroller and includes steps of:
when the pneumatic nail gun is powered on, determining whether the sensing signal is received from the wheel sensor;
controlling the motor to drive the lifting wheel to rotate to lift the striking pin when it is determined that the sensing signal is not received; and
controlling the motor to stop the lifting wheel from rotating upon receiving the sensing signal from the wheel sensor.

Another object of the disclosure is to provide a pneumatic nail gun that can alleviate at least one of the drawbacks of the prior art.

According to the disclosure, the pneumatic nail gun includes a main body, a cylinder device that is disposed in the main body, a striking device that is movably disposed in the cylinder device, a lifting wheel that is configured to move said striking device, a motor that is configured to drive the lifting wheel to rotate to lift the striking device, and a control device.

The control device includes a microcontroller and a wheel sensor electrically connected to the microcontroller. The wheel sensor is configured to generate and output a sensing signal to the microcontroller when detecting that the lifting wheel is at a predetermined angular position where the lifting wheel has lifted the striking device to arrive at a ready-to-strike position. The microcontroller is configured to determine whether the sensing signal is received from the wheel sensor when the pneumatic nail gun is powered on, to control the motor to drive the lifting wheel to rotate to lift the striking device when it is determined that the sensing signal is not received, and to control the motor to stop the lifting wheel from rotating upon receiving the sensing signal from the wheel sensor.

### BRIEF DESCRIPTION OF THE DRAWINGS

Other features and advantages of the disclosure will become apparent in the following detailed description of the embodiments with reference to the accompanying drawings, of which:

FIG. 1 is a schematic view of a part of a conventional pneumatic nail gun disclosed in U.S. Pat. No. 8,011,547;

FIG. 2 is a perspective view of a pneumatic nail gun according to an embodiment of the disclosure;

FIG. 3 is a sectional view of a portion of the pneumatic nail gun according to an embodiment of the disclosure, illustrating a striking device at a ready-to-strike position;

FIG. 4 is a block diagram of a control device and related elements of the pneumatic nail gun according to an embodiment of the disclosure;

FIG. 5 and FIG. 6 are sectional views similar to FIG. 3, illustrating the striking device being at a struck position and stuck at an abnormal position, respectively;

FIG. 7 is a flow chart illustrating an embodiment of an operation method for operating the pneumatic nail gun; and

FIG. 8 is a flow chart illustrating another embodiment of an operation method for operating the pneumatic nail gun.

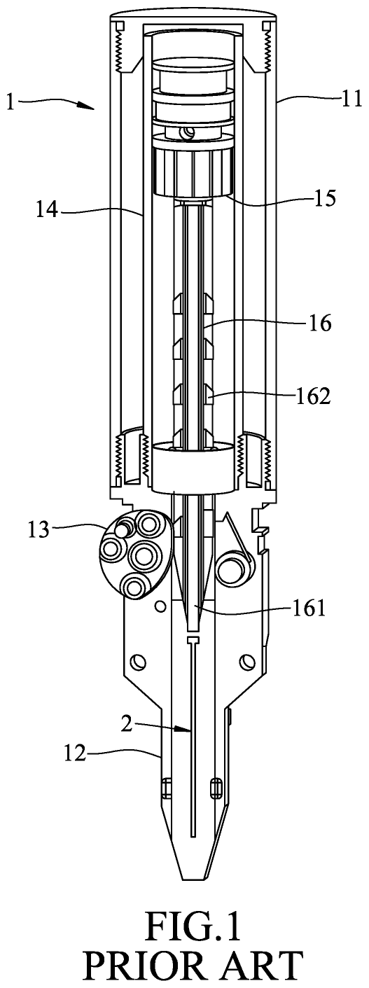

### DETAILED DESCRIPTION

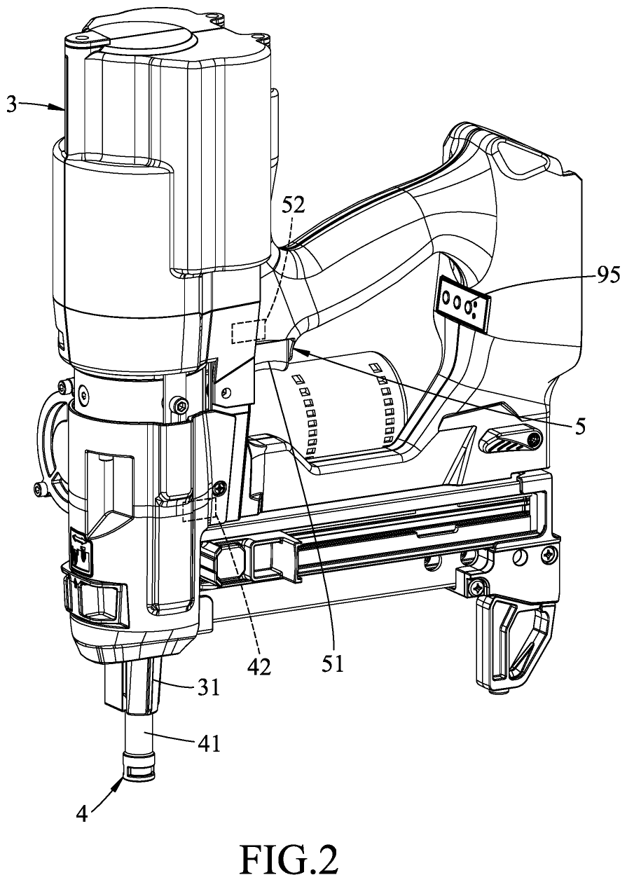

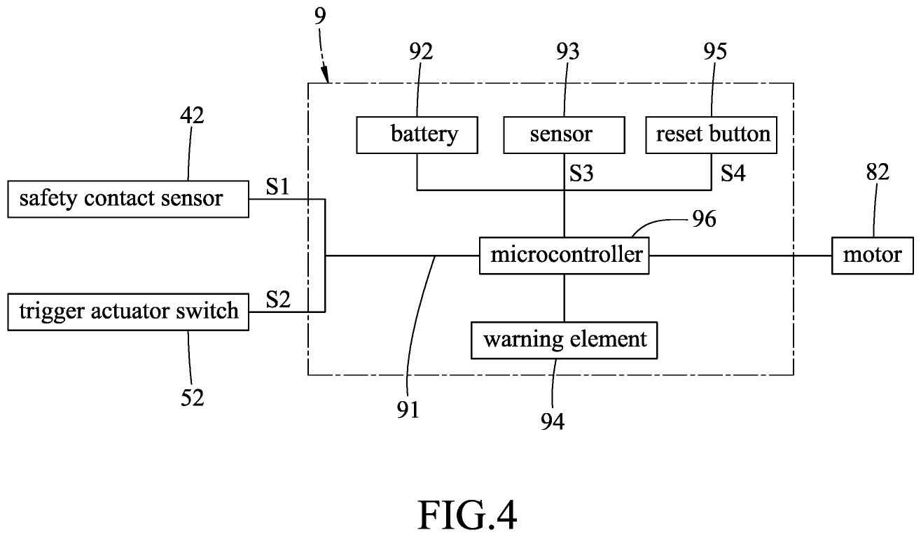

Referring to FIGS. 2 to 4, an embodiment of a pneumatic nail gun according to the disclosure includes a main body 3, a safety device 4, a trigger device 5, a cylinder device 6, a striking device 7, a lifting device 8 and a control device 9.

The main body 3 includes a muzzle 31 adapted to be loaded with a nail (not shown).

The safety device 4 includes a safety contact element 41 adapted to be pressed against a solid surface, and a safety contact sensor 42 configured to be actuated by the safety contact element 41 to generate a safety contact signal (S1) when the safety contact element 41 is pressed against the solid surface. For example, the safety contact sensor 42 is an infrared sensor, a photodetector, a touch switch, a touch button, or the like.

The trigger device 5 is mounted on the main body 3, and includes a trigger 51 adapted to be pulled by a person's finger, and a trigger actuator switch 52 configured to be triggered by the trigger 51 to generate a trigger signal (S2) when the trigger 51 is pulled. For example, the trigger actuator switch 52 is a touch switch.

The cylinder device 6 is disposed in the main body 3 and includes a cylinder 61 connected to the muzzle 31, and a tank 62 that defines a storage chamber in fluidic communication with an inner space of the cylinder 61.

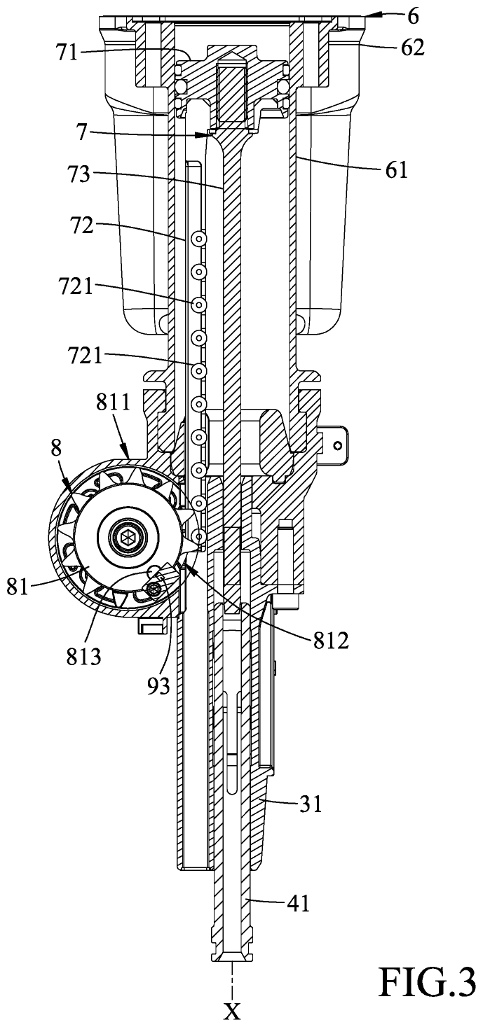

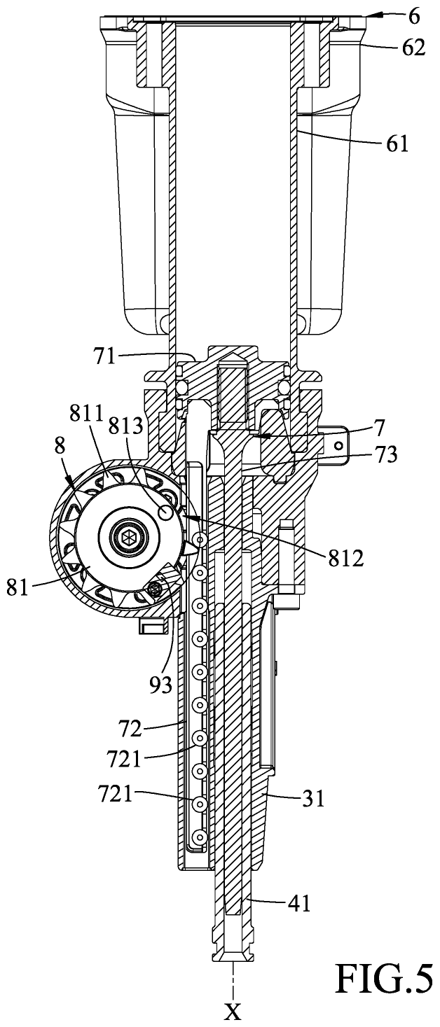

The striking device 7 is movably disposed in the cylinder device 6 and includes a piston 71, a lifting rod 72 and a nail-striker 73. The piston 71 is linearly movable along an axis (X) between an upper position that is distal from the muzzle 31 (as shown in FIG. 3) and a lower position that is proximate to the muzzle 31 (as shown in FIG. 5). The axis (X) extends along a direction in which a nail is fired. The lifting rod 72 is connected to the piston 71, and includes a plurality of engaging teeth 721 that are spaced apart from each other and that are arranged parallel to the axis (X). The nail-striker 73 is connected to the piston 71, is in a form of a rod extending along the axis (X), and is adapted for striking the nail out of the muzzle 31.

The lifting device 8 includes a lifting wheel 81 that is disposed rotatably in the main body 3 and is adjacent to the muzzle 31, and a motor 82 that is configured to drive the lifting wheel 81 to rotate to lift the striking device 7. In this embodiment, the lifting wheel 81 is driven to only rotate unidirectionally, i.e., in a counterclockwise direction from the perspective of FIG. 3. The lifting wheel 81 has a toothed circumferential portion 811, a smooth circumferential portion 812 that is not toothed, and a reference component 813 that is disposed near the smooth circumferential portion 812. The toothed circumferential portion 811 and the smooth circumferential portion 812 cooperatively define a circumference of the lifting wheel 81. In this embodiment, the reference component 813 is a magnet.

The control device 9 is disposed in the main body 3, and includes a battery 92 for supplying power to the pneumatic nail gun, a wheel sensor 93 for sensing the reference component 813, a warning element 94, a reset button 95, and a microcontroller 96 that is electrically connected to the battery 92, the wheel sensor 93, the motor 82, the warning element 94, the reset button 95, the safety contact sensor 42 and the trigger actuator switch 52.

In this embodiment, the wheel sensor 93 is a magnetic inductor or a magnetic field sensor, and is disposed near the lifting wheel 81 to detect a magnetic field generated by the reference component 813.

When the lifting wheel 81 is rotated to arrive at a predetermined angular position, where the striking device 7 is lifted by the lifting wheel 81 to arrive at a ready-to-strike position, as shown in FIG. 3, the wheel sensor 93 would detect the presence of the reference component 813, and accordingly generate and output a sensing signal (S3) to the microcontroller 96. It should be noted that, at the ready-to-strike position, the piston 71 is moved to the upper position distal from the muzzle 31 (as shown in FIG. 3).

The warning element 94 is controlled by the microcontroller 96 to generate and output a warning signal. In this embodiment, the warning element 94 is a lamp, and the warning signal is in a form of light.

In another embodiment, the warning element 94 is a buzzer, and the warning signal is in a form of sound.

The reset button 95 is mounted on the main body 3, and is configured to be operated by a user to generate and output a reset signal (S4) to the microcontroller 96.

It will be understood that the various directional nomenclature used below is with respect to an orientation of the pneumatic nail gun illustrated in FIGS. 3, 5 and 6, while the pneumatic nail gun can be used in many other angular positions without departing from the principles described below of the present invention.

FIG. 5 shows that the striking device 7 is at a struck position where the piston 71 is proximate to the muzzle 31. It can be appreciated that the struck position is a position where the striking device 7 has moved to after firing a nail, and the piston 71 is at the lower position. At this time, when the motor 82 drives the lifting wheel 81 to rotate in the counterclockwise direction, the toothed circumferential portion 811 engages one of the engaging teeth 721 of the lifting rod 72 to move the lifting rod 72 upwardly (i.e., toward an upper side of the pneumatic nail gun). The lifting rod 72 then pushes the piston 71, together with the striking pin 73, to move upwardly from the lower position to the upper position distal from the muzzle 31. In the process of moving the piston 71 upwardly, the gas in the inner space of the cylinder 61 and the storage chamber of the tank 62 is compressed, thereby increasing the gas pressure inside the cylinder 61 and the tank 62.

As shown in FIG. 3, when the lifting wheel 81 arrives at the predetermined angular position, the toothed circumferential portion 811 of the lifting wheel 81 engages one of the engaging teeth 721 that is farthest from the piston 71, and the wheel sensor 93 detects the presence of the reference component 813 and thus outputs the sensing signal (S3) to the microcontroller 96. The microcontroller 96 controls the motor 82 to stop driving the lifting wheel 81 to rotate. At that instant, the striking device 7 arrives at the ready-to-strike position.

When the safety contact element 41 is pressed against a solid surface and the trigger 51 is pulled, the safety contact sensor 42 outputs the safety contact signal (S1) to the microcontroller 96 and the trigger actuator switch 52 outputs the trigger signal (S2) to the microcontroller 96. Upon receiving the safety contact signal (S1) and the trigger signal (S2), the microcontroller 96 controls the motor 82 to drive the lifting wheel 81 to start to rotate again in the counterclockwise direction. Then, the smooth circumferential portion 812 of the lifting wheel 81 is turned to face the engaging teeth 721 such that the engaging teeth 721 disengage from the lifting wheel 81. At this time, the gas pressure inside the cylinder device 6 drives the piston 71 together with the nail-striker 73 to quickly move downward. During this movement, the nail-striker 73 moves along the axis (X) towards the muzzle 31 to strike the nail.

After striking the nail, the striking device 7 is moved to the struck position, and the toothed circumferential portion 811 then engages one of the engaging teeth 721 that is nearest to the piston 71 again, as shown in FIG. 5.

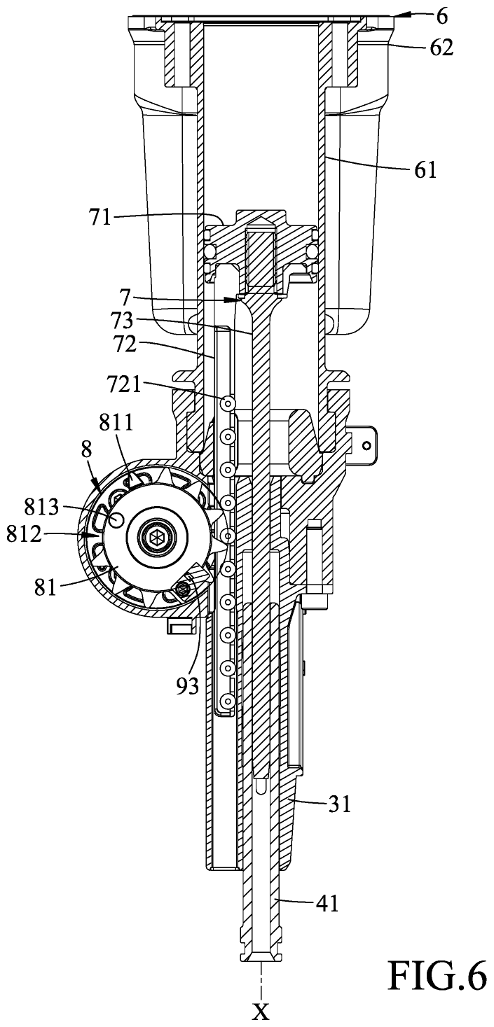

In an instance that some type of jam occurs so the striking device 7 cannot complete its travel to the fullest extent during a driving stroke, the pneumatic nail gun needs to be powered off, e.g., dismounting the battery 92, for resolving the jam. However, even if the jam has been resolved, the striking device 7 may still be at an abnormal position as shown in FIG. 6.

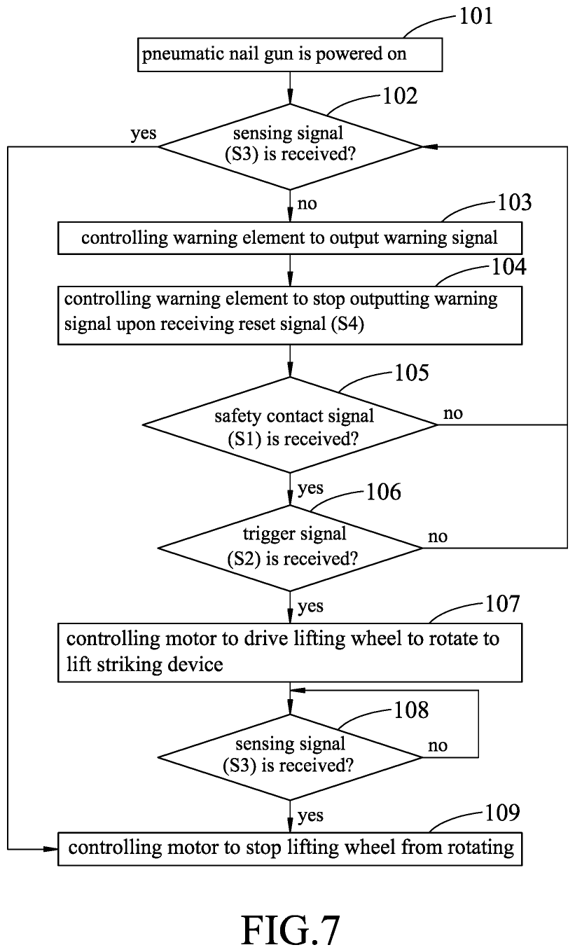

Referring to FIGS. 2, 4, 6 and 7, one embodiment of an operation method for operating the pneumatic nail gun includes the following steps.

In step 101, the pneumatic nail gun is powered on. Specifically, when a jam occurs, the battery 92 may be dismounted so that the pneumatic nail gun is powered off, and after resolving the jam, the battery 92 may be installed again so that the pneumatic nail gun is powered on.

In step 102, the microcontroller 96 determines whether the sensing signal (S3) is received from the wheel sensor 93. When the determination made in this step is affirmative, it means that the striking device 7 is at the ready-to-strike position (normal), and the process goes to step 109. When it is determined that the sensing signal (S3) is not received, it means that the striking device 7 is at an abnormal position (e.g., a position shown in FIG. 6), and the process goes to step 103.

In step 103, the microcontroller 96 controls the warning element 94 to output the warning signal.

A user would be aware that the striking device 7 is now at an abnormal position when he/she notices the warning signal. In this embodiment, if the user wants the striking device 7 to be moved back to the ready-to-strike position from the abnormal position, he/she should press the reset button 95 for repeatedly implementing the following steps of the operation method.

In step 104, the microcontroller 96 controls the warning element 94 to stop outputting the warning signal upon receiving the reset signal (S4) from the reset button 95. At this moment, the user should implement strike actions, i.e., operating the safety contact element 41 pressed against the solid surface and then pulling the trigger 51.

In step 105, the microcontroller 96 determines whether the safety contact signal (S1) is received from the safety contact sensor 42 in a first predetermined period of time, e.g., 5 seconds. The process goes to step 106 when the determination made in this step is affirmative, and the process goes back to step 102 when otherwise.

In step 106, the microcontroller 96 determines whether the trigger signal (S2) is received from the trigger actuator switch 52 in a second predetermined period of time, e.g., 5 seconds. The process goes to step 107 when the determination made in this step is affirmative, and the process goes back to step 102 when otherwise.

In step 107, when both the safety contact signal (S) and the trigger signal (S2) are received, the microcontroller 96 controls the motor 82 to drive the lifting wheel 81 to rotate to lift the striking device 7.

In step 108, the microcontroller 96 keeps determining whether the sensing signal (S3) is received from the wheel sensor 93 (i.e., the microcontroller 96 repeats the determination of whether the sensing signal (S3) is received until the sensing signal (S3) is received). Only when the determination made in this step is affirmative, the process goes to step 109. At this instant, the lifting wheel 81 arrives at the predetermined angular position, and the striking device 7 is at the ready-to-strike position as shown in FIG. 3.

In step 109, the microcontroller 96 controls the motor 82 to stop the lifting wheel 81 from rotating.

In this way, the striking device 7 is moved back to the ready-to-strike position under proper operations of the user, and is ready to strike a nail.

In another embodiment, step 104 may be omitted. That is to say, if the user wants the striking device 7 to be moved back to the ready-to-strike position, he/she only has to implement the strike actions, without pressing the reset button 95. In such embodiment, in step 109, the microcontroller 96 further controls the warning element 94 to stop outputting the warning signal.

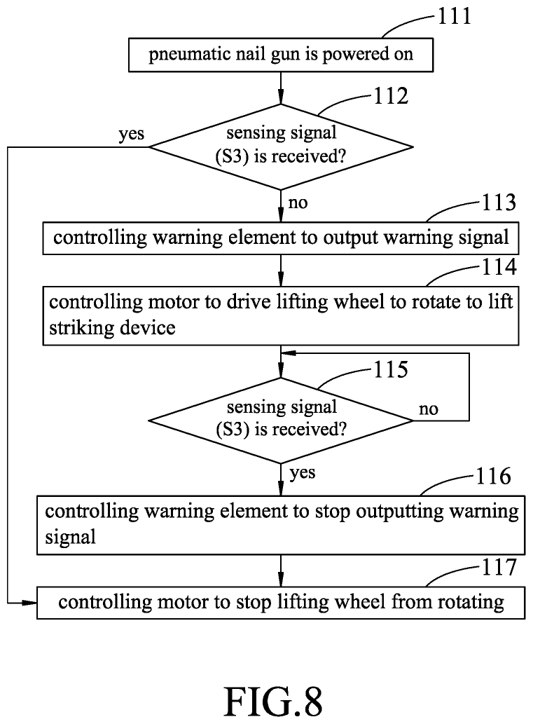

Referring to FIGS. 2, 4, 6 and 8, another embodiment of the operation method for operating the pneumatic nail gun includes the following steps.

In step 111, the pneumatic nail gun is powered on.

In step 112, the microcontroller 96 determines whether the sensing signal (S3) is received from the wheel sensor 93. When the determination made in this step is affirmative, the process goes to step 117. When it is determined that the sensing signal (S3) is not received, the process goes to step 113.

In step 113, the microcontroller 96 controls the warning element 94 to output the warning signal.

In this embodiment, if the user wants the striking device 7 to be moved back to the ready-to-strike position from the abnormal position, he/she should press the reset button 95.

In step 114, the microcontroller 96 controls the motor 82 to drive the lifting wheel 81 to rotate to lift the striking device 7 upon receiving the reset signal (S4) from the reset button 95.

In step 115, the microcontroller 96 keeps determining whether the sensing signal (S3) is received from the wheel sensor 93. Only when the determination made in this step is affirmative does the process go to step 116. At that instant, the lifting wheel 81 arrives at the predetermined angular position, and the striking device 7 is at the ready-to-strike position as shown in FIG. 3.

In step 116, the microcontroller 96 controls the warning element 94 to stop outputting the warning signal.

In step 117, the microcontroller 96 controls the motor 82 to stop the lifting wheel 81 from rotating.

In view of the above, the pneumatic nail gun can check the position of the striking device 7 automatically and output a warning signal to notify the user when the striking device 7 is at an abnormal position. Consequently, the user can immediately perform proper operations to resolve the problem in an appropriate manner. Further, the lifting wheel 81 can be driven to rotate to lift the striking device 7 under the control of the microcontroller 96 via correct operations of the user, so damage to the pneumatic nail gun due to improper operation can be avoid.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. An operation method for a pneumatic nail gun, the pneumatic nail gun including a striking device, a lifting wheel, a motor that is configured to drive the lifting wheel to rotate to lift the striking device, and a control device that includes a microcontroller and a wheel sensor electrically connected to the microcontroller, the wheel sensor being configured to generate and output a sensing signal to the microcontroller when detecting that the lifting wheel is at a predetermined angular position where the lifting wheel has lifted the striking device to arrive at a ready-to-strike position, the operation method being implemented by the microcontroller and comprising steps of:
when the pneumatic nail gun is powered on, determining whether the sensing signal is received from the wheel sensor;
controlling the motor to drive the lifting wheel to rotate to lift the striking device when it is determined that the sensing signal is not received; and
controlling the motor to stop the lifting wheel from rotating upon receiving the sensing signal from the wheel sensor.

2. The operation method as claimed in claim 1, the pneumatic nail gun further including a warning element electrically connected to the microcontroller, the operation method further comprising a step of:
when it is determined that the sensing signal is not received, controlling the warning element to output a warning signal.

3. The operation method as claimed in claim 2, further comprising a step of:
controlling the warning element to stop outputting the warning signal upon receiving the sensing signal from the wheel sensor.

4. The operation method as claimed in claim 2, the pneumatic nail gun further including a reset button electrically connected to the microcontroller and configured to be operated to generate and output a reset signal to the microcontroller, the operation method further comprising, after the step of controlling the warning element to output a warning signal and before the step of controlling the motor to drive the lifting wheel to rotate, a step of:
controlling the warning element to stop outputting the warning signal upon receiving the reset signal from the reset button.

5. The operation method as claimed in claim 2, the pneumatic nail gun further including a reset button electrically connected to the microcontroller and configured to be operated to generate and output a reset signal to the microcontroller,
wherein the step of controlling the motor to drive the lifting wheel to rotate is implemented only after the microcontroller receives the reset signal from the reset button.

6. The operation method as claimed in claim 5, further comprising a step of:
controlling the warning element to stop outputting the warning signal upon receiving the sensing signal from the wheel sensor.

7. The operation method as claimed in claim 1, the pneumatic nail gun further including a safety contact element adapted to be pressed against a solid surface, a trigger, and a safety contact sensor and a trigger actuator switch both electrically connected to the microcontroller, the safety contact sensor being configured to be actuated by the safety contact element to generate and output a safety contact signal to the microcontroller when the safety contact element is pressed against the solid surface, the trigger actuator switch being configured to be triggered by the trigger to generate and output a trigger signal to the microcontroller when the trigger is pulled,
wherein the step of controlling the motor to drive the lifting wheel to rotate is implemented only after the microcontroller receives both the safety contact signal and the trigger signal.

8. The operation method as claimed in claim 7, further comprising, before the step of controlling the motor to drive the lifting wheel to rotate, a step of:
determining whether a first criterion that the safety contact signal is received in a first predetermined time, and a second criterion that the trigger signal is received in a second predetermined time are both satisfied,
wherein the step of controlling the motor to drive the lifting wheel to rotate is implemented only when it is determined that the first and second criterions are both satisfied.

9. A pneumatic nail gun, comprising:
a main body;
a cylinder device that is disposed in said main body;
a striking device that is movably disposed in said cylinder device;
a lifting wheel that is configured to move said striking device;
a motor that is configured to drive said lifting wheel to rotate to lift said striking device; and
a control device that includes a microcontroller and a wheel sensor electrically connected to said microcontroller,
wherein said wheel sensor is configured to generate and output a sensing signal to said microcontroller when detecting that said lifting wheel is at a predetermined angular position where said lifting wheel has lifted said striking device to arrive at a ready-to-strike position,
wherein said microcontroller is configured to determine whether the sensing signal is received from said wheel sensor when said pneumatic nail gun is powered on, to control said motor to drive said lifting wheel to rotate to lift said striking device when it is determined that the sensing signal is not received, and to control said motor to stop said lifting wheel from rotating upon receiving the sensing signal from said wheel sensor.

10. The pneumatic nail gun as claimed in claim 9, further comprising:
a safety contact element for abutting against a solid surface;
a trigger;
a safety contact sensor electrically connected to said microcontroller, and configured to be actuated by said safety contact element to generate and output a safety contact signal to said microcontroller when said safety contact element is pressed against the solid surface; and
a trigger actuator switch electrically connected to said microcontroller, and configured to be triggered by said trigger to generate and output a trigger signal to said microcontroller when said trigger is pulled;
wherein said microcontroller is configured to control said motor to drive said lifting wheel to rotate only after receiving both the safety contact signal and the trigger signal.

11. The pneumatic nail gun as claimed in claim 10, further comprising:
a warning element electrically connected to said microcontroller;
wherein said microcontroller is further configured to control said warning element to generate and output a warning signal when it is determined that the sensing signal is not received.

12. The pneumatic nail gun as claimed in claim 11, further comprising:
a reset button electrically connected to said microcontroller, and configured to be operated to generate and output a reset signal to said microcontroller;
wherein said microcontroller is further configured to control said warning element to stop outputting the warning signal upon receiving the reset signal from said reset button.

13. The pneumatic nail gun as claimed in claim 9, further comprising:
a reset button electrically connected to said microcontroller, and configured to be operated to generate and output a reset signal to said microcontroller;
wherein said microcontroller is further configured to control said motor to drive said lifting wheel to rotate only after receiving the reset signal from said reset button.

14. The pneumatic nail gun as claimed in claim 9, wherein said lifting wheel has a reference component, and said wheel sensor detects presence of said reference component for determining whether said lifting wheel is at the predetermined angular position.
